(19) United States
(12) Patent Application Publication
(10) Pub. No.: US 2023/0234021 A1
(43) Pub. Date: Jul. 27, 2023

(54) Gas adsorbent, preparation method of same, and speaker box using same

(71) Applicant: AAC Microtech (Changzhou) Co., Ltd., Changzhou City (CN)

(72) Inventors: Jie Zhang, Shenzhen (CN); Hezhi Wang, Shenzhen (CN); Zhongyang Wang, Shenzhen (CN)

(21) Appl. No.: 17/833,878

(22) Filed: Jun. 6, 2022

(30) Foreign Application Priority Data
Jan. 26, 2022 (CN) 202210093865.1

(51) Int. Cl. B01J 20/18; B01J 20/26; B01J 20/28; B01J 20/30; H04R 1/02; H04R 1/28

(52) U.S. Cl. CPC B01J 20/18; B01J 20/261; B01J 20/2803; B01J 20/28021; B01J 20/3007; H04R 1/025; H04R 1/288

(57) ABSTRACT

The present invention provides a gas adsorbent comprising a number of microspheres formed by agglomeration of zeolite and adhesive. Among the plurality of microspheres, at least some of the microspheres have a porous structure and contain inflatable balls inside. In the present invention, the high molecular polymer expansion ball is added into the zeolite microsphere, and more pore structures are created in the zeolite microsphere by utilizing its characteristics of expansion, solidification and rupture at different temperatures. Thus, the adsorption capacity of the zeolite microsphere to air is increased to achieve a better frequency reduction effect.

### FIELD OF THE PRESENT DISCLOSURE

The present invention relates to the technical field of electroacoustic transducers, in particular to a gas adsorbent used in a speaker box, a preparation method of the gas adsorbent, and a speaker box using the gas adsorbent.

### DESCRIPTION OF RELATED ART

Inside the cavity of the speaker, when the speaker is working, the vibration diaphragm moves back and forth to change the air pressure inside the cavity, which in turn hinders the movement of the vibration diaphragm, thereby distorting the sound waves it emits.

After the speaker is packaged, the effect of the cavity size on the overall resonance frequency is that the smaller the cavity (the greater the rigidity, the greater the obstacle to the free movement of the vibration diaphragm), the higher the resonance frequency. As a multi-pore structure material, molecular sieve can continuously adsorb and desorb the air in the cavity when the cavity vibrates, thereby indirectly increasing the volume of the cavity. Limited by the overall size of portable equipment such as mobile phones. In order to obtain a better low-frequency speaker effect, on the one hand, we require the resonant frequency of the product to be as low as possible. On the other hand, speaker cavity is expected to be as small as possible to save space, which requires the development of cavity filling materials with higher frequency reduction performance.

The amount of gas adsorbed by the molecular sieve is the key to determining the frequency reduction effect. the development of a molecular sieve microsphere with more pore structures means that the molecular sieve microsphere can absorb more air under the same volume, thereby achieving a better frequency reduction effect.

### SUMMARY OF THE PRESENT INVENTION

The purpose of the present invention is to provide a gas adsorbent having a better adsorption effect.

Accordingly, the present invention provides a gas adsorbent, comprising: a plurality of microspheres formed by agglomeration of zeolite and adhesive; wherein at least selected amount of the microspheres has a porous structure and contains inflatable balls inside.

In addition, the zeolite is one or more of structural types such as MFI, FER, and MEL; a skeleton structure of the zeolite is mainly composed of silicon oxide and aluminum oxide, wherein the weight ratio of silicon to aluminum is 50-800.

In addition, a particle size of the inflatable ball before expansion is the first size, and the particle size of the inflatable ball after the expansion is the second size; the second size is between 1% and 20% of the average size of the microsphere.

In addition, an inflatable ball particle size is expandable from the first size to the second size at a first temperature; the inflatable ball collapses and releases gas at the second temperature to leave a pore structure inside the microsphere.

In addition, the inflatable ball includes: a thermoplastic housing body comprising high molecular polymers; the housing body softens when heated, and expands in volume when subjected to pressure; and wherein inflatable ball further includes an inner filler which is a liquid alkane, and the inner filler vaporizes when heated, thereby increasing the internal pressure of the inflatable ball.

The present invention further provides a method for preparing the gas adsorbent as described above, comprising steps of:

mixing zeolite powder, inflatable ball, adhesive with water to prepare an aqueous suspension;

preparing suspended droplets by applying pressure to the aqueous suspension through a nozzle, and obtaining solid particles by freezing the suspension droplets;

drying the solid particles at low temperature to obtain an initial microsphere, a particle diameter of the inflatable ball in the initial microsphere being defined as a first size;

obtaining middle microsphere after the expansion of the inflatable ball after the initial microsphere is placed at the first temperature and heated; an particle diameter of the inflatable ball in the middle microsphere being defined as the second size;

obtaining the gas adsorbent by the intermediate microsphere placed at the second temperature.

In addition, a weight ratio of described zeolite powder, water, adhesive and inflatable ball is 1: (0.6˜1.5): (0.03˜0.15): (0.002˜0.04).

In addition, the first temperature is 80˜190° C., and the second temperature is greater than or equal to 200° C.

In addition, an weight of described inflatable ball is 0.1%-5% of the weight of zeolite.

In addition, the middle microsphere is cooled to room temperature and then heated to the second temperature.

The present invention further provides a speaker, comprising: a housing body with a containment space, a sounding unit placed in the housing body, and a rear cavity surrounded by the sounding unit and the housing body, wherein the rear cavity is filled with the gas adsorbent as described above.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure

FIG. 1 is a structural diagram of the speaker box provided by the present invention;

FIG. 2 is a flow chart view of the preparation method of gas adsorbent provided by the present invention;

FIG. 3 is a scanning electron microscope view of the initial shape of the inflatable ball provided by the present invention;

FIG. 4 is a scanning electron microscope view of the shape of the inflatable ball provided by the present invention after being heated at the first temperature;

FIG. 5 is a scanning electron microscope view of the shape of the inflatable ball provided by the present invention after being heated at a second temperature;

FIG. 6 is a scanning electron microscope view of the gas adsorbent in the embodiment of the present invention;

FIG. 7 is a scanning electron microscope view of the outer surface of the microsphere in the embodiment of the present invention;

FIG. 8 is an internal scanning electron microscope view of the microsphere in the embodiment of the present invention.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby are only to explain the disclosure, not intended to limit the disclosure.

The present invention provides a gas adsorbent comprising a plurality of microspheres formed by agglomeration of zeolite and adhesive, the zeolite is one or more in structural types such as MFI, FER, MEL, the skeleton structure of the zeolite is mainly composed of silicon oxide and aluminum oxide, wherein the weight ratio of silicon to aluminum is 50-800.

Among the plurality of microspheres, at least some of the microspheres have a porous structure and contain inflatable balls inside. The particle size before the expansion of the inflatable ball is the first size, the particle size after the expansion of the inflatable ball at the first temperature is the second size, the second size is between 1% and 20% of the average size of the microsphere. The inflatable ball ruptures and shrinks at the second temperature and releases gas, so as to leave a pore structure inside the microsphere, so that the microsphere is arranged with a porous structure, thereby improving the gas adsorbent's ability to adsorb gas.

The inflatable ball includes: A thermoplastic housing body, the housing body is composed of a high molecular polymer, the housing body softens when heated, and expands in volume when subjected to pressure; inner filler, the inner filler is a liquid alkane, and the inner filler gaseous when heated, thereby increasing the internal pressure of the inflatable ball.

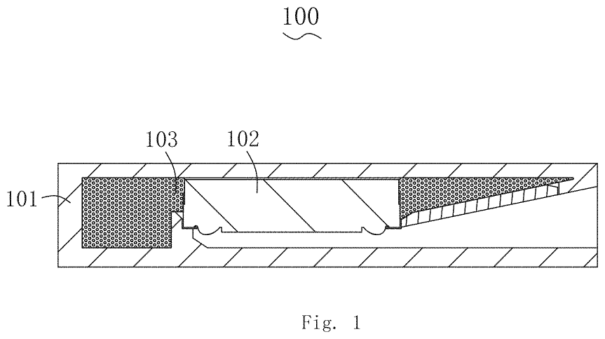

As shown in FIG. 1, a speaker box 100 provided by the present invention includes a housing body 1 with a containment space and a speaker unit 2 contained in the containment space. Speaker unit 2 and housing body 1 are surrounded to form rear cavity 3. The gas adsorbent is filled in the rear cavity 3 to increase the acoustic compliance of the air in the rear cavity, thereby improving the low-frequency acoustic performance of the speaker.

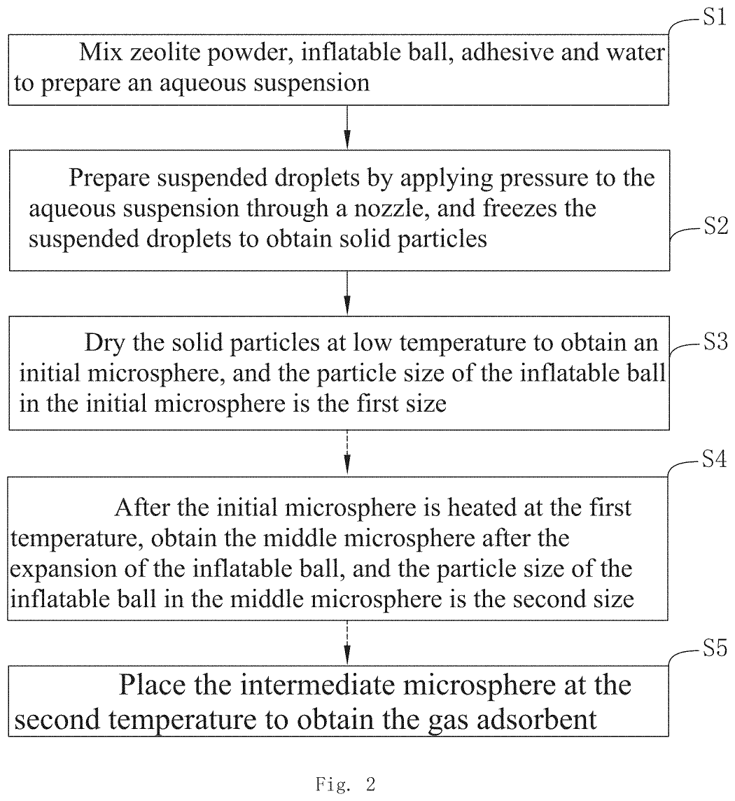

As shown in FIG. 2, the preparation method of the gas adsorbent provided by the present invention is carried out according to the following steps:

S1. Mix zeolite powder, inflatable ball, adhesive and water to prepare an aqueous suspension;

S2. Prepare suspended droplets by applying pressure to the aqueous suspension through a nozzle, and freezes the suspended droplets to obtain solid particles;

S3. Dry the solid particles at low temperature to obtain an initial microsphere, and the particle size of the inflatable ball in the initial microsphere is the first size;

S4. After the initial microsphere is heated at the first temperature, obtain the middle microsphere after the expansion of the inflatable ball, and the particle size of the inflatable ball in the middle microsphere is the second size;

S5. Place the intermediate microsphere at the second temperature to obtain the gas adsorbent.

More specifically, the preparation method for preparing gas adsorbent includes:

Weigh zeolite powder, water, polymer adhesive and inflatable ball; wherein the weight ratio of zeolite powder, deionized water, polymer adhesive and inflatable ball is 1: (0.6˜1.5): (0.03˜0.15): (0.002˜0.04). The amount of inflatable ball added needs to be controlled within a reasonable range. Too little inflatable ball addition will not show the effect of increasing the internal pore structure, adding too much inflatable ball will lead to too much pore structure inside the microsphere, then the mechanical strength reduces and the sphere collapses;

Mix zeolite powder, deionized water, polymer adhesive and inflatable ball powder to obtain a suspension;

Stir the appeal suspension at room temperature for 3-5 h, so that the components are evenly distributed in the suspension;

Use the filter screen to filter the stirred suspension, and place the filtration gained suspension in the granulation device;

The suspension is dispersed into small droplets of uniform size by a granulation device, and the initial microsphere is obtained after freeze-drying;

The initial microsphere obtained above was placed in an oven at 80-190° C. for 2-4 h, then taken out and cooled at room temperature, the inflatable ball polymer housing in the microsphere softens at this temperature, the internal liquid alkane gasifies and the pressure increases, so that a hollow structure is formed inside the microsphere, after cooling at room temperature, the hollow structure tends to be stabilized to obtain an intermediate microsphere;

The above middle microsphere is placed in a 200-250° C. oven for 5-15 min, then taken out and cooled at room temperature, among them, the housing of inflatable ball ruptures and shrinks at this temperature, releasing the internal gas, leaving the pores, the lower temperature and shorter baking time will not shrink the glue in the sample, avoid clogging the pores in the microsphere or reduce the mechanical strength, the cooled sample is the gas adsorbent provided by the present invention. In other optional embodiments, the intermediate microsphere is placed in a vacuum oven at 150-200° C. for 10 minutes, taken out and cooled at room temperature to obtain the gas adsorbent provided by the present invention. That is, in the vacuum environment, in the preparation method of the gas adsorbent, the second temperature can be lowered to 150-200° C.

Embodiment of the present invention provides a specific method for preparing gas adsorbent, which includes:

1. Weigh ZSM-5 (MFI) zeolite 20 g, deionized water 20 g, acrylic acid adhesive 2 g, inflatable ball powder 0.2 g;

2. Mix the raw materials uniformly to obtain a suspension;

3. Continue to stir the suspension at room temperature for 2 h, ultrasonically immerse it for 0.5 h, and then continue to stir for 2 h;

4. Continue to filter the suspension with a 300-mesh filter;

5. Continue to disperse the suspension into small droplets of uniform size through the granulation device, and the droplets are frozen into solid particles after entering the cooling tower;

6. Put the solid particles into a vacuum drying oven at −40° C. and dry for 12 h to obtain the initial microsphere;

7. Put the initial microsphere into a 150° C. oven for 2 h, take it out and cool it at room temperature for 0.5 h to obtain an intermediate microsphere;

8. Put the middle microsphere into 210 DEG C. of ovens for 10 min, take out and cool at room temperature for 0.5 h to obtain the gas adsorbent.

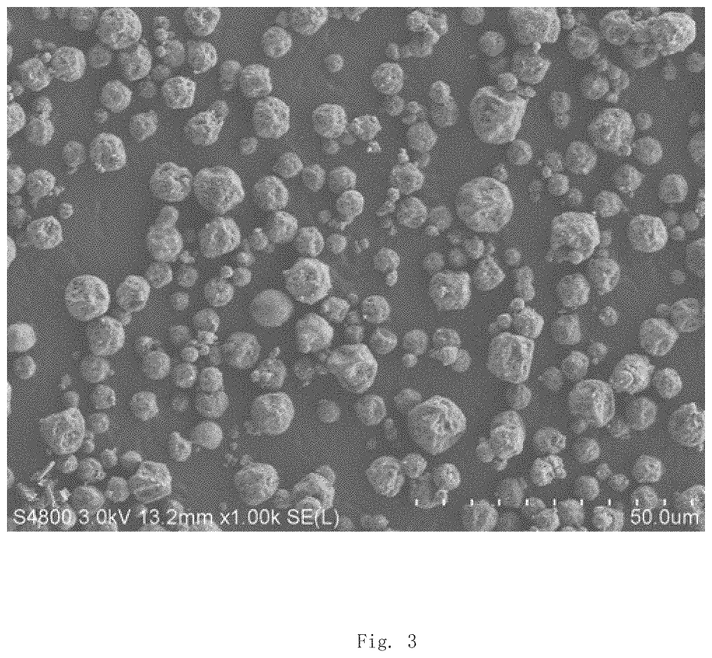

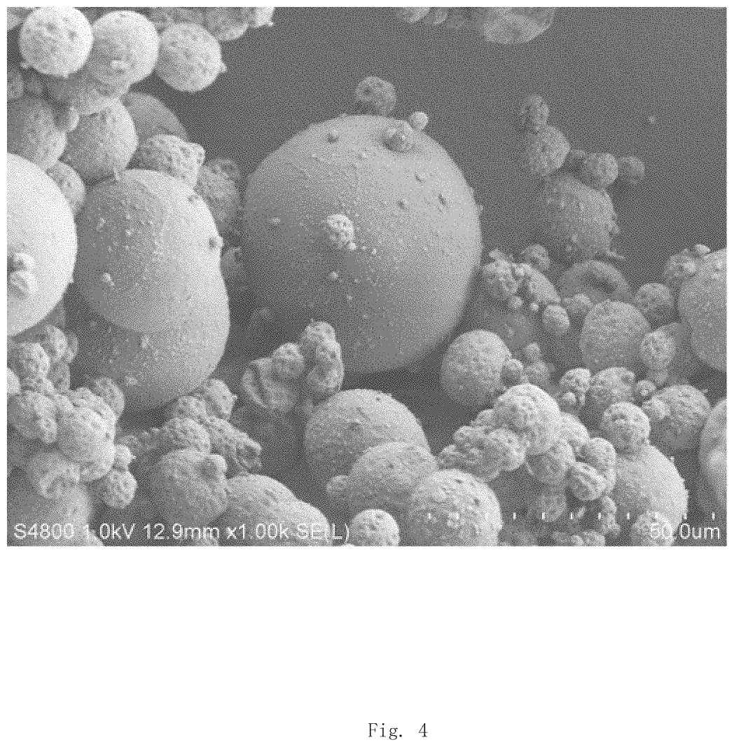

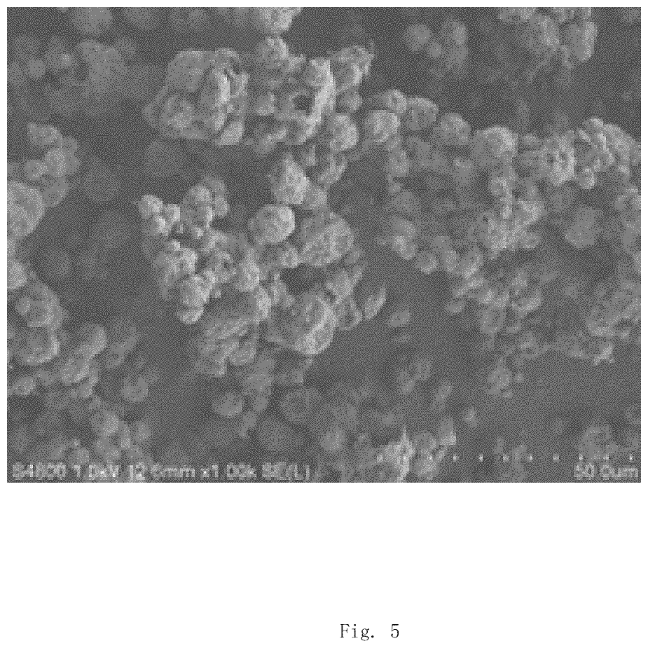

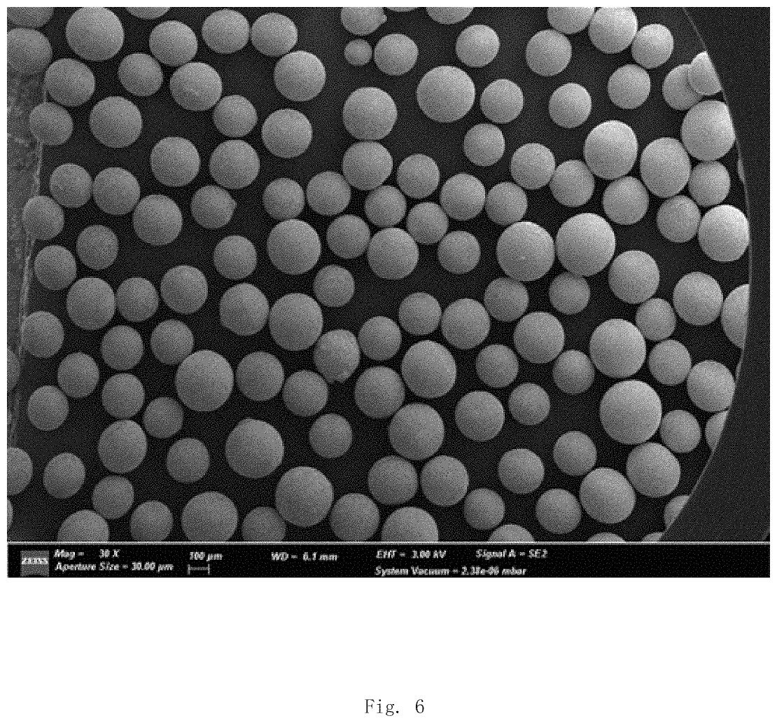

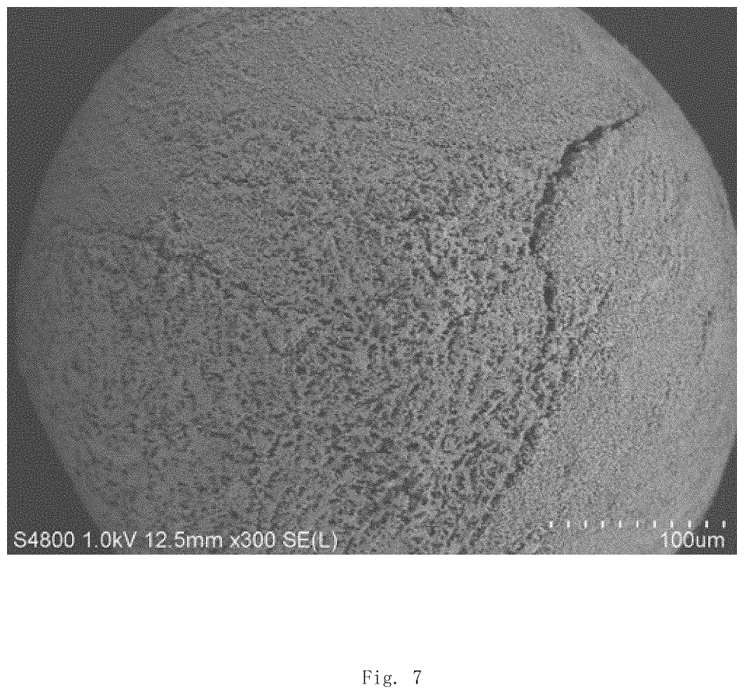

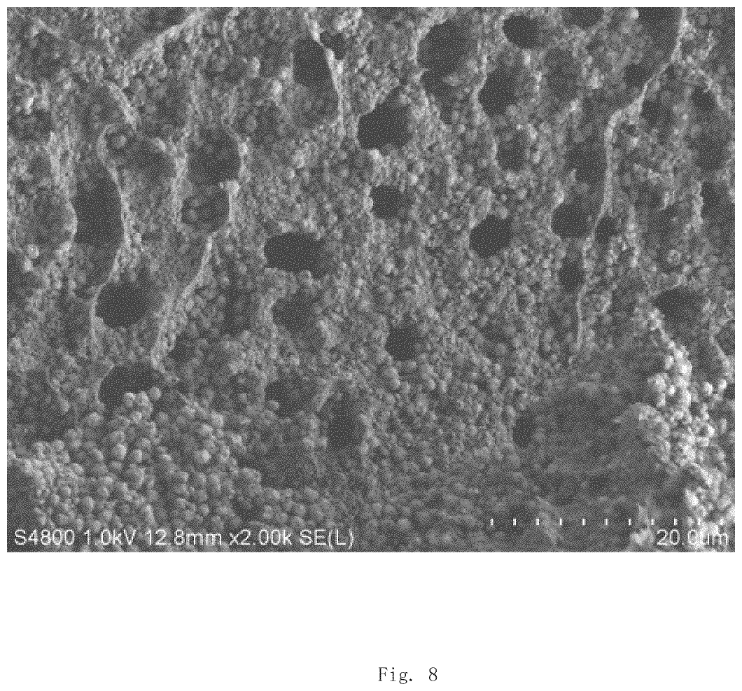

FIG. 3-5 are the scanning electron microscope view of the initial shape of the inflatable ball provided by the present invention, the shape after heating at the first temperature, and the shape after heating at the second temperature. It can be seen from FIG. 3-4 that after the inflatable ball is heated to the first temperature, the particle size of the inflatable ball increases from the first size to the second size. FIG. 6 is a scanning electron microscope view of the gas adsorbent in the embodiment of the present invention. FIGS. 7-8 are respectively the outer surface of the gas adsorbent microsphere and the inner scanning electron microscope view in the embodiment of the present invention. Comparing FIG. 4 and FIGS. 6-7, the second size is between 1% and 20% of the average size of the microsphere particle size. As can be seen from FIGS. 4-5 and FIG. 8, the inflatable ball ruptures and shrinks at the second temperature and releases gas, leaving a pore structure inside the microsphere, in this way, the microsphere has a porous structure, thereby significantly improving the gas adsorption capability of the gas adsorbent provided by the present invention.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A gas adsorbent, comprising: a plurality of microspheres formed by agglomeration of zeolite and adhesive; wherein at least selected amount of the microspheres has a porous structure and contains inflatable balls inside.

2. The gas adsorbent according to claim 1, wherein the zeolite is one or more of structural types such as MFI, FER, and MEL; a skeleton structure of the zeolite is mainly composed of silicon oxide and aluminum oxide, wherein the weight ratio of silicon to aluminum is 50-800.

3. The gas adsorbent according to claim 1, wherein a particle size of the inflatable ball before expansion is the first size, and the particle size of the inflatable ball after the expansion is the second size; the second size is between 1% and 20% of the average size of the microsphere.

4. The gas adsorbent according to 3, wherein an inflatable ball particle size is expandable from the first size to the second size at a first temperature; the inflatable ball collapses and releases gas at the second temperature to leave a pore structure inside the microsphere.

5. The gas adsorbent according to claim 1, wherein the inflatable ball includes:
a thermoplastic housing body comprising high molecular polymers; the housing body softens when heated, and expands in volume when subjected to pressure; and wherein inflatable ball further includes an inner filler which is a liquid alkane, and the inner filler vaporizes when heated, thereby increasing the internal pressure of the inflatable ball.

6. A method for preparing the gas adsorbent as claimed in claim 1, comprising steps of:
mixing zeolite powder, inflatable ball, adhesive with water to prepare an aqueous suspension;
preparing suspended droplets by applying pressure to the aqueous suspension through a nozzle, and obtaining solid particles by freezing the suspension droplets;
drying the solid particles at low temperature to obtain an initial microsphere, a particle diameter of the inflatable ball in the initial microsphere being defined as a first size;
obtaining middle microsphere after the expansion of the inflatable ball after the initial microsphere is placed at the first temperature and heated; an particle diameter of the inflatable ball in the middle microsphere being defined as the second size;
obtaining the gas adsorbent by the intermediate microsphere placed at the second temperature.

7. The method according to claim 6, wherein a weight ratio of described zeolite powder, water, adhesive and inflatable ball is 1: (0.6˜1.5): (0.03˜0.15): (0.002˜0.04).

8. The method according to claim 6, wherein the first temperature is 80˜190° C., and the second temperature is greater than or equal to 200° C.

9. The method according to claim 6, wherein an weight of described inflatable ball is 0.1%˜5% of the weight of zeolite.

10. The method according to claim 6, wherein the middle microsphere is cooled to room temperature and then heated to the second temperature.

11. A speaker, comprising: a housing body with a containment space, a sounding unit placed in the housing body, and a rear cavity surrounded by the sounding unit and the housing body, wherein the rear cavity is filled with the s gas adsorbent as described in claim 1.
